(19) United States
(12) Patent Application Publication
(10) Pub. No.: US 2026/0288131 A1
(43) Pub. Date: Sep. 24, 2026

(54) INTERACTIVE ALARM

(71) Applicant: Yokogawa Electric Corporation, Tokyo (JP)

(72) Inventors: Aiswarya PRASANNAKUMAR, Singapore (SG); Bijuraj PANDIYATH VELAYUDHAN, Singapore (SG)

(21) Appl. No.: 19/083,753

(22) Filed: Mar. 19, 2025

(51) Int. Cl. G05B 23/02; G06N 3/08

(52) U.S. Cl. CPC G05B 23/027; G05B 23/0254; G06N 3/08

(57) ABSTRACT

Industrial sites utilize process components, or "tags," to perform, monitor, and control industrial processes. When an alarm occurs, it can be critical to quickly execute an action to best resolve the alarm. Providing an operator with a prioritized list of recommended actions to a particular alarm enables the user to quickly identify and take the recommended action to resolve the alarm. The recommendation may be determined by an artificial intelligence, such as a trained neural network, analyzing process components and their interrelationships associated with an alarm.

### FIELD OF THE DISCLOSURE

The invention relates generally to systems and methods for determining the root cause of an alarm in a complex environment and particularly to interactively determining a root cause and recommendation best determined to resolve the alarm.

### BACKGROUND

A complex environment, such as chemical manufacturing facilities, pharmaceutical plants, crude oil refineries, industrial kitchens, power generation facilities, etc., may have a large number of sensing components/sensors. Sensing components can monitor production (e.g., flow in a pipe, temperature or pressure in a component, etc.), the operation of a component (e.g., the position of a valve, the speed of a motor, etc.) and/or the surrounding environment, such as the detection of fire, smoke, leaks, vibration, etc. The sensing components/sensors are connected to controllers through a field network that supports communication between devices connected thereto.

An alarm may indicate that a particular sensor's (or sensors') value is outside of a normal operating range, but such information has limited use. The root cause for the alarm may be addressed by altering a setting of a different component. For example, an abnormal temperature in a process may be caused by a number of other components (e.g., a valve has been set incorrectly or has failed, a blockage, contamination is present, the wrong feed stock has been added, etc.). For many industrial processes, one alarm, such as an abnormal temperature, may be one of many alarms potentially flooding the operators with information.

During an alarm state, processes may be suspended, produce unusable outputs that require complex disposal or reclamation efforts, or indicate actual damage or a potential for damage. Knowing how to resolve the alarm quickly is important to return the complex environment to normal operation and avoid an escalation of issues.

### SUMMARY

Complex environments are commonly utilized to perform one or more complex processes, such as producing a chemical or pharmaceutical, refining crude oil, producing a food product, generating power, etc. Due to the large size, large volume, need for precision, etc. of the processes they perform, complex environments may utilize hundreds or thousands of components dedicated to monitoring a portion of at least one process and/or controlled as a part of the at least one process. Many of the components are related, such as to work in parallel, work in series, provide a process input, and/or monitor a process output. These components, commonly referred to as "tags," report a current state or operational attribute. The component may be observational (e.g., reporting temperature of a monitored portion of an industrial process) and/or controllable (e.g., position of a valve). Quickly determining how to resolve an alarm triggered by one or more components is critical to maintaining the safe and efficient operation of the complex environment.

The above and other needs are addressed by the various embodiments and configurations of the present invention. The present invention can provide a number of advantages depending on the particular configuration. These and other advantages will be apparent from the disclosure of the invention(s) contained herein.

In one embodiment, an alarm occurs and is presented in an alarm display (e.g., a device display, application window, etc.) to show the alarm and relevant facts associated with the alarm, such as causal factors and/or the relevant trends for one or more components. A recommended action may be provided. The user can interact with the recommendation, such as to be presented with the rationale behind the action, such as how other components – one of which is reporting the alarm—will be impacted by the action. The user may query or be automatically presented with historical alarms of the same or similar nature and actions that were taken in the past and their effect on that particular alarm and/or other operational attributes of the components. As a benefit, an inexperienced operator can make informed decisions and handle alarms quickly and effectively. Once the user does the action this is also saved so that it can be used for further analysis.

In another embodiment, a causal intelligence engine will read log files of events reported by components and any associated alarms from a database. The analysis of the log files will show trends that may be determined to indicate that an alarm state is likely or inevitable and/or what prior actions successful or unsuccessfully resolved a prior alarm state.

In another embodiment, when an alarm occurs, first the alarm details will be collected. Then causal intelligence engine will read the timeseries database (DB) to get the details of all the components or tags (the list of tags which need to be read will be coming from the plant information). The alarm database will be checked to get the previous occurrences of the alarm as well as other alarms which occurred during the same time or as a cause of this alarm, for example, a plurality of sequentially occurring alarms within a time period will be identified and analyzed. The engine will then read the operator logs to see how the alarm was handled in the past, for example, if the same alarm happened five times before, and for each alarm occurrence of the five times, operator performed certain operator actions (e.g. changed tag 1 or others) to resolve the alarm, the causal intelligence engine will analyze the past operator actions, if the past operator actions (i.e. operational attribute) are the same (e.g. changed tag 1 or others), then that operational attribute (i.e. changed tag 1 or others) could be a “primary” operational attribute (with high importance) for feeding to training. Further, changes of other parameters (e.g. tag 2, tag 3) (other operational attributes) because of changes of the “primary” operational attribute (tag 1) will also be used for training, which can be regarded as “secondary” operational attributes. It will also obtain the result of that handling from the timeseries database (e.g., the value of the tag went down, etc.). Based on this the causal intelligence engine will pull up the trends of the relevant tags. It will analyze the timeseries database to understand the tag trends to see how the yield depends on tag values. From the result of the timeseries database analysis and past alarm handling it will accurately recommend actions so that the alarm can be handled and the yield is not affected. The causal factors are obtained from the plant information database. Additionally, these details are learned from different systems/databases and the details will be collected and shown efficiently to the user in one screen. The user can then ask the engine more details or questions about the alarm. The engine will analyze the questions and give all relevant information. Based on the information, the user can make an informed decision.

For example, when an alarm happens, the causal intelligence engine will read values of the tags associated with the alarm from the plant information database. The engine will get the trends of the tags and show them in a user interface, such as Tag 1, 7, 13, 12, with causal factors changes in value, percentages, state, etc., for the tags having different values. These values are obtained from past alarms as well as plant information. The recommendation says to increase the setpoint value of Tag 12 and Tag 24. This recommendation is created with the help of past data (e.g., operator logs, the timeseries database, etc.) as well as the current values.

As used herein the term "industrial processes" refers to a process, which may be one process of a plurality of processes, that utilizes a plurality, often thousands, of components to execute and/or monitor the process. Industrial processes may themselves be complex due to the number of steps, high degree of precision, large volume of inputs, etc., and/or complex due to the complexities of the environment, such as the scale at which the process is performed. For example, a hydroelectric dam generates electricity in a straightforward process; however, generating electricity at such a commercial scale requires careful coordination of many components. Components utilized in the industrial process are configured to report a sensed state (e.g., temperature, pressure, speed of a motor, etc.) and/or be controllable (e.g., a remotely controlled valve, speed of a motor, etc.).

In some aspects, the techniques described herein relate to a computer-implemented method of training a neural network for alarm resolution actions, including: collecting a set of past operational attributes of an industrial process; applying one or more transformations to each of the past operational attributes of the set of past operational attributes of an industrial including altering the degree of a first transformation of the one or more transformations, altering the order of the one or more transformations applied to two or more past operational attributes, including a second transformation to an omitted one of the past operational attributes of the set of past operational attributes, and omitting at least one transformation of the one or more transformations to an included one of the past operational attributes to create a modified set of past operational attributes; creating a first training set including the collected set of past operational attributes, the modified set of past operational attributes, and a set of extraneous operational attributes of the industrial process not associated with a prior alarm; training the neural network in a first stage using the first training set; creating a second training set for a second stage of training including the first training set and the set of extraneous operational attributes of the industrial process not associated with any prior alarms incorrectly identified as impacting the prior alarm; and training the neural network in the second stage using the second training set.

In some aspects, the techniques described herein relate to a computer-implemented method, further including: receiving an alarm associated with the industrial process reporting an alarm state of at least one operational attribute of the industrial process; and in response to the alarm: providing a set of operational attributes of the industrial process and the alarm to the neural network to receive a recommended resolution action from the neural network; presenting, on a graphical user interface (GUI), an indicium of the recommended resolution action and at least one action different from the recommended resolution action; receiving a selected action identifying one of the recommended resolution action and the at least one action different from the recommended resolution action; and modifying at least one process component of the industrial process in accordance with the selected action.

In some aspects, the techniques described herein relate to a computer-implemented method, wherein: the recommended resolution action is a plurality of prioritized recommended resolution actions; presenting a recommendation on the GUI includes presenting, in priority order, the plurality of prioritized recommended resolution actions; receiving the selected action identifying one of the plurality of prioritized recommended resolution actions and the at least one action different from the plurality of prioritized recommended resolution actions; and modifying at least one process component of the industrial process in accordance with the selected action.

In some aspects, the techniques described herein relate to a computer-implemented method, wherein the priority order is one or more of a faster resolution of the alarm, fewer waste products generated by the industrial process, less risk of an escalation alarm, and lower resource requirements.

In some aspects, the techniques described herein relate to a computer-implemented method, further including: monitoring the impact of the selected action on the set of operational attributes; and providing feedback to the neural network including the selected action and the impact.

In some aspects, the techniques described herein relate to a method, wherein the set of operational attributes include a set of one or more of a reading from a sensor, a parameter of a process component utilized by the industrial process, and a parameter of an algorithm utilized to operate one or more process components utilized by the industrial process.

In some aspects, the techniques described herein relate to a computer-implemented method, including: collecting a set of operational attributes of an industrial process; analyzing the set of operational attributes to identify subsets of operational attributes being interdependent; receiving an alarm for the industrial process; and in response to the alarm: identifying a subset of operational attributes associated with the alarm; identifying a first operational attribute, of the subset of operational attributes associated with the alarm, triggering the alarm; identifying a second operational attribute interdependent on the first operational attribute; presenting indicium of the second operational attribute on a graphical user interface (GUI) and receiving a modification input therefrom; and modifying the second operational attribute in accordance with the modification input.

In some aspects, the techniques described herein relate to a computer-implemented method, wherein: identifying the subset of operational attributes associated with the alarm includes identifying a plurality of subsets of operational attributes associated with the alarm; identifying the first operational attribute, of the subset of operational attributes associated with the alarm, triggering the alarm, includes identifying a set of first operational attributes, of each of the plurality of subsets of operational attributes associated with the alarm, triggering the alarm; identifying the second operational attribute interdependent on the first operational attribute includes identifying the second operational attributes interdependent on the set of first operational attributes; and presenting indicium of the second operational attribute on the GUI and receiving the modification input therefrom includes presenting a set of indicia of the second operational attribute on the GUI and receiving the modification input therefrom.

In some aspects, the techniques described herein relate to a computer-implemented method, further including: prioritizing the set of second operational attributes to form a prioritized list of second operational attributes; and moving indicium of the highest priority of the prioritized list of second operational attributes closest to a highest priority location of the GUI.

In some aspects, the techniques described herein relate to a computer-implemented method, further including: moving indicia of the highest priority operational attributes of the set of second operational attributes closest to a highest priority location of the GUI based on priority.

In some aspects, the techniques described herein relate to a computer-implemented method, wherein the priority of the highest priority operational attributes is one or more of a faster resolution of the alarm, fewer waste products generated by the industrial process, less risk of an escalation alarm, and lower resource requirements.

In some aspects, the techniques described herein relate to a computer-implemented method, wherein analyzing the set of operational attributes to identify subsets of operational attributes being interdependent, includes: collecting a set of past operational attributes of an industrial process; applying one or more transformations to each of the past operational attributes of the set of past operational attributes including altering the degree of a first transformation of the one or more transformations, altering the order of the one or more transformations applied to two or more past operational attributes, including a second transformation to an omitted one of the set of past operational attributes, and omitting at least one transformation of the one or more transformations to an included one of the set of past operational attributes to create a modified set of past operational attributes; creating a first training set including the collected set of past operational attributes, the modified set of past operational attributes, and a set of extraneous operational attributes of the industrial process not associated with a prior alarm; training a neural network in a first stage using the first training set; creating a second training set for a second stage of training including the first training set and the set of extraneous operational attributes of the industrial process not associated with any prior alarms incorrectly identified as impacting the prior alarm; and training the neural network in the second stage using the second training set.

In some aspects, the techniques described herein relate to a computer-implemented method, wherein the set of operational attributes include a set of one or more of: a reading from a sensor, a parameter of a process component utilized by the industrial process, and a parameter of an algorithm utilized to operate one or more process components utilized by the industrial process.

In some aspects, the techniques described herein relate to a system, including: a database; and a processor, coupled to a computer memory maintaining thereon instructions to cause the processor to execute the instructions; and wherein the instructions cause the processor to perform: collecting a set of past operational attributes of an industrial process from the database; applying one or more transformations to each of the past operational attributes of the set of past operational attributes including altering the degree of a first transformation of the one or more transformations, altering the order of the one or more transformations applied to two or more past operational attributes, including a second transformation to an omitted one of the past operational attributes of set of past operational attributes, and omitting at least one transformation of the one or more transformations to an included one of the past operational attributes of the set of past operational attributes to create a modified set of past operational attributes; creating a first training set including the collected set of past operational attributes, the modified set of past operational attributes, and a set of extraneous operational attributes of the industrial process not associated with a prior alarm; training a neural network in a first stage using the first training set; creating a second training set for a second stage of training including the first training set and the set of extraneous operational attributes of the industrial process not associated with any prior alarms incorrectly identified as impacting the prior alarm; and training the neural network in the second stage using the second training set.

In some aspects, the techniques described herein relate to a system, further including: a network interface to a network; and a user device including the processor and a graphical user interface (GUI); and wherein the instructions further cause the processor to perform: receiving, via the network, an alarm associated with the industrial process reporting an alarm state of at least one operational attribute of the industrial process; in response to the alarm: providing a set of operational attributes of the industrial process and the alarm to the neural network to receive a recommended resolution action from the neural network; presenting, on the GUI, indicium of the recommended resolution action and at least one action different from the recommended resolution action; receiving a selected action identifying the recommended resolution action and the at least one action different from the recommended resolution action; and modifying at least one process component of the industrial process in accordance with the selected action.

In some aspects, the techniques described herein relate to a system, wherein: the recommended resolution action is a plurality of prioritized recommended resolution actions; presenting the recommended resolution action on the GUI includes presenting, in priority order, the plurality of prioritized recommended resolution actions; receiving the selected action identifying the recommended resolution action and the at least one action different from the recommended resolution action includes receiving the selected action identifying one of the plurality of prioritized recommended resolution actions and the at least one action different from the plurality of prioritized recommended resolution actions; and modifying at least one process component of the industrial process in accordance with the selected action includes modifying at least one process component of the industrial process in accordance with the selected action.

In some aspects, the techniques described herein relate to a system, wherein presenting the recommended resolution action on the GUI includes presenting, in the priority order, the plurality of prioritized recommended resolution actions and further includes moving indicium of the highest priority of the plurality of prioritized recommended resolution actions closest to a highest priority location of the GUI.

In some aspects, the techniques described herein relate to a system, wherein the priority order is one or more of a faster resolution of the alarm, fewer waste products generated by the industrial process, less risk of an escalation alarm, and lower resource requirements.

In some aspects, the techniques described herein relate to a system, wherein the instructions further cause the processor to perform: monitoring the impact of the selected action on the set of operational attributes; and providing feedback to the neural network including the selected action and the impact.

In some aspects, the techniques described herein relate to a system, wherein the set of operational attributes include a set of one or more of a reading from a sensor, a parameter of a process component utilized by the industrial process, and a parameter of an algorithm utilized to operate one or more process components utilized by the industrial process.

A system on a chip (SoC) including any one or more of the above aspects or aspects of the embodiments described herein.

One or more means for performing any one or more of the above or aspects of the embodiments described herein.

Any aspect in combination with any one or more other aspects.

Any one or more of the features disclosed herein.

Any one or more of the features as substantially disclosed herein.

Any one or more of the features as substantially disclosed herein in combination with any one or more other features as substantially disclosed herein.

Any one of the aspects/features/embodiments in combination with any one or more other aspects/features/embodiments.

Use of any one or more of the aspects or features as disclosed herein.

Any of the above aspects or aspects of the embodiments described herein, wherein the data storage comprises a non-transitory storage device, which may further comprise at least one of: an on-chip memory within the processor, a register of the processor, an on-board memory co-located on a processing board with the processor, a memory accessible to the processor via a bus, a magnetic media, an optical media, a solid-state media, an input-output buffer, a memory of an input-output component in communication with the processor, a network communication buffer, and a networked component in communication with the processor via a network interface.

It is to be appreciated that any feature described herein can be claimed in combination with any other feature(s) as described herein, regardless of whether the features come from the same described embodiment.

The phrases "at least one," "one or more," "or," and "and/or" are open-ended expressions that are both conjunctive and disjunctive in operation. For example, each of the expressions "at least one of A, B, and C," "at least one of A, B, or C," "one or more of A, B, and C," "one or more of A, B, or C," "A, B, and/or C," and "A, B, or C" means A alone, B alone, C alone, A and B together, A and C together, B and C together, or A, B, and C together.

The term "a" or "an" entity refers to one or more of that entity. As such, the terms "a" (or "an"), "one or more," and "at least one" can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware , an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible, non-transitory medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below. Also, while the disclosure is presented in terms of exemplary embodiments, it should be appreciated that an individual aspect of the disclosure can be separately claimed.

### BRIEF DESCRIPTION OF THE DRAWINGS

The present disclosure is described in conjunction with the appended figures:

FIG. 1 depicts a system in accordance with embodiments of the present disclosure;

FIG. 2 depicts a system with an alarm display in accordance with embodiments of the present disclosure;

FIG. 3 depicts a process in accordance with embodiments of the present disclosure; and

FIG. 4 depicts a device of a system in accordance with embodiments of the present disclosure.

### DETAILED DESCRIPTION

The ensuing description provides embodiments only and is not intended to limit the scope, applicability, or configuration of the claims. Rather, the ensuing description will provide those skilled in the art with an enabling description for implementing the embodiments. It will be understood that various changes may be made in the function and arrangement of elements without departing from the spirit and scope of the appended claims.

Any reference in the description comprising a numeric reference number, without an alphabetic sub-reference identifier when a sub-reference identifier exists in the figures, when used in the plural, is a reference to any two or more elements with the like reference number. When such a reference is made in the singular form, but without identification of the sub-reference identifier, it is a reference to one of the like numbered elements, but without limitation as to the particular one of the elements being referenced. Any explicit usage herein to the contrary or providing further qualification or identification shall take precedence.

The exemplary systems and methods of this disclosure will also be described in relation to analysis software, modules, and associated analysis hardware. However, to avoid unnecessarily obscuring the present disclosure, the following description omits well-known structures, components, and devices, which may be omitted from or shown in a simplified form in the figures or otherwise summarized.

For purposes of explanation, numerous details are set forth in order to provide a thorough understanding of the present disclosure. It should be appreciated, however, that the present disclosure may be practiced in a variety of ways beyond the specific details set forth herein.

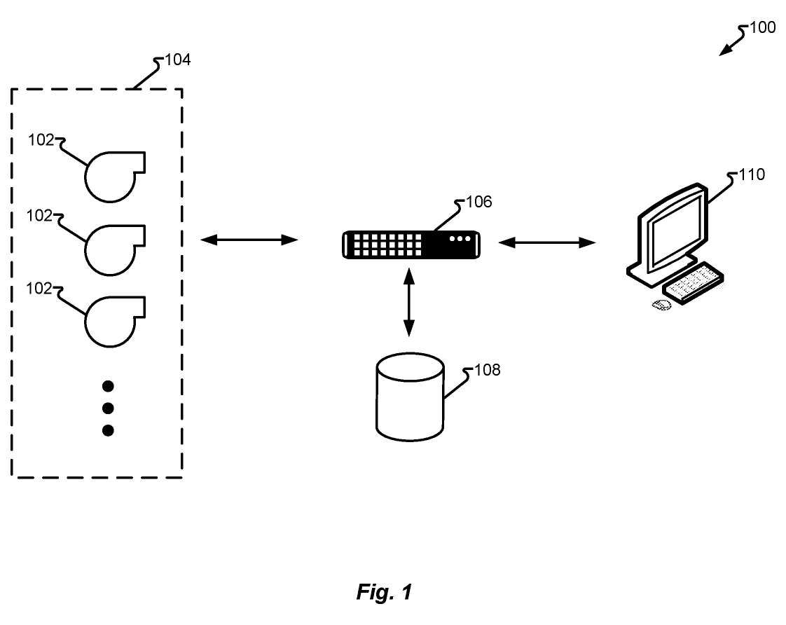

FIG. 1 illustrates system 100 in accordance with embodiments of the present disclosure. In one embodiment, system 100 illustrates components comprising process components 102, computing components 106, 108, and 110 and a data storage component (e.g., data storage 108) interconnected, such as via a network. It should be appreciated that, in one embodiment, each of the illustrated components provides a single service. However, one of ordinary skill in the art will recognize that other topologies may be deployed without departing from the scope of embodiments herein. For example, server 106 may be combined with data storage 108, computer 110 and/or other computing or data storage components. In another embodiment, any one computing component may be embodied as a plurality of computing components. In one embodiment, the components as illustrated perform a single function; in other embodiments, one or more computing components may perform a plurality of functions and/or one or more functions may be performed by a plurality of computing components including as a service (e.g., software as a service (SaaS)). In yet another embodiment, the connection topology may be the topology as illustrated in system 100, or another topology, without departing from the scope of the embodiments.

In one embodiment, industrial site 104 comprises a plurality of process components 102. Each of process components 102 reports sensed information to server 106, receives operational commands from server 106, or both. Any two or more components 102 may be the same type of device or different types of devices.

The sensed information describes an operational attribute of the process being performed by industrial site 104. The operational attributes may be reported individually or further processed into groups, trends, exceptions, alarms, etc., by server 106. Operational attributes may be the current or desired state of one or more process components 102 (e.g., an oven heating to a desired setpoint, speed setting of a fan, etc.). Process components 102 perform and/or monitor an industrial process or processes at industrial site 104. In a further embodiment, at least one process component 102 may monitor environmental states that impact the industrial process (e.g., ambient temperature, load on a power grid, water level in a reservoir, etc.).

Computer 110 comprises a display and may present information to a user (e.g., an operator at industrial site 104). Similarly, data storage 108 may maintain logs of individual operational attributes (e.g., events, states, etc.) and/or processed operational attributes, such as groupings of individual operational attributes, trends over time, settings, states, overrides, exceptions, alarms, etc.

In another embodiment, server 106 may execute an artificial intelligence (AI), such as a neural network. The neural network is trained to identify alarms and their resolutions. Recommendations are provided by the neural network, such as may be presented on computer 110 for user selection or override to resolve a current alarm triggered by at least one process component 102. Additionally or alternatively, server 106 may automatically execute an alarm resolution action comprising altering an operational attribute of one or more process components 102.

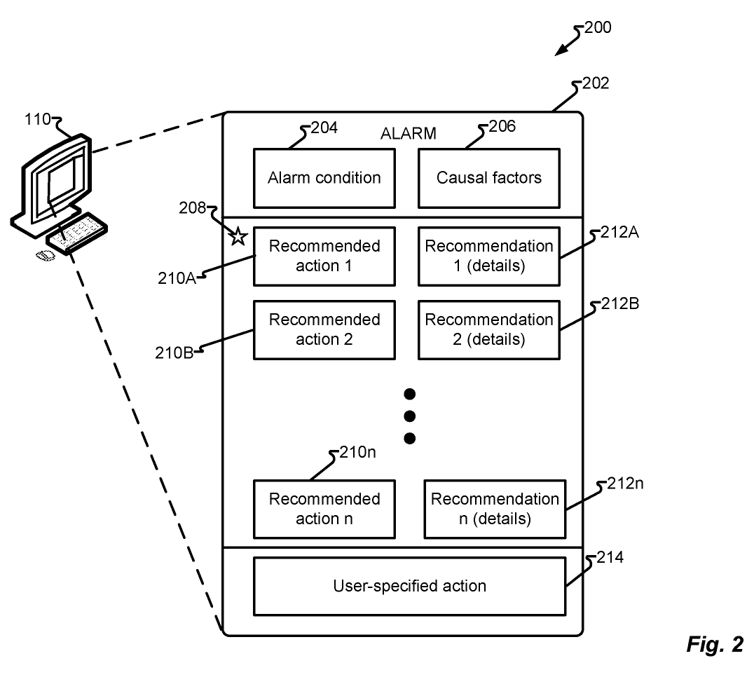

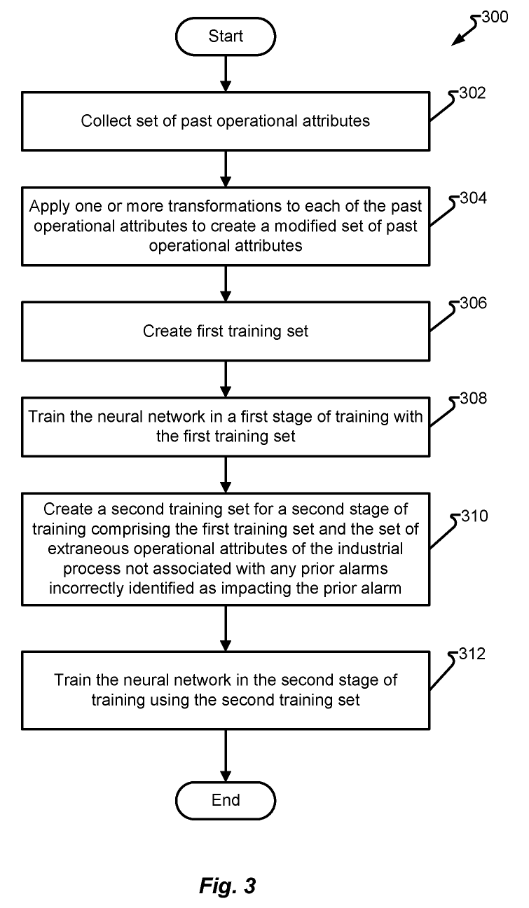

FIG. 2 depicts system 200 with alarm display 202 in accordance with embodiments of the present disclosure. In one embodiment, alarm display 202 is presented on computer 110 which receives analysis from server 106 (described in more detail with respect to FIG. 3). As described above, computer 110 is variously embodied. In one embodiment, computer 110 is a stand-alone desktop or portable computer running an application presenting alarm display 202. In another embodiment, computer 110 may be co-embodied with server 106. In another embodiment, computer 110 may be co-embodied with one or more process components 102, such as a control panel. Computer 110 may be located at industrial site 104 or remotely located and communicated via a network, such as the internet, a satellite link, cellular or wired telephony network, etc.

Alarm display 202 may be presented continually, such as to indicate the absence of any alarm, or "pop-up" only when an alarm condition occurs. The contents of alarm display may include alarm condition 204 to indicate the issue, such as one or more process components 102 are operating or observing a state of an industrial process that is outside of the normal range of operational parameter values In one embodiment, alarm condition 204 is a clear description of the fault or undesired condition of the industrial process (e.g., "Tank overpressure"). Causal factors 206 provides details on which process component(s) 102 are associated with the alarm and the values they observed (e.g., "Tag 37 -- 13.9 bar, "Tag 53 – 133% of normal," etc.), and/or over time (e.g., "Tag 21 – increased from 8.5 kv to 13.1 kv in the last 30 minutes"). Causal factors 206 may be retrieved from a database, such as one maintained by data storage 108, that indicate how values reported from particular process component(s) 102 will trigger a particular alarm. For example, alarms may be indexed or otherwise identified such that when "Alarm X" occurs, computer 110 and/or server 106 retrieve a record from data storage 108 that identifies the particular process components 102 associated with the alarm and obtains values from those particular process components 102 for reporting.

In another embodiment, alarm display 202 presents one or more recommended actions 210. Optionally, the one or more recommended actions 210 may be presented with (automatically or in response to receiving a user's input) corresponding recommendation details 212. Each of recommended actions 210 may provide an indicium of the recommended resolution (e.g., "stop motor X", “open valve Y”, “increase pump speed”) and/or a more descriptive term (e.g., "open the circuit breaker to motor X", “open valve Y to 20%”, “increase pump speed to 30% of full speed”) and/or descriptive details may be provided by recommendation details 212. The recommendations may be provided by an AI agent running on computer 110 or server 106 (described in more detail with respect to FIG. 3). Recommended actions 210 may further be prioritized, such that recommended action 1 (210A) is moved closest to highest priority location 208, which is closer to the highest priority location than the next highest recommendation (i.e., recommended action 2 (210B)), and so on through recommended action n (210n). The content presented by recommended actions 210 and the corresponding recommendation details 212 is variously embodied. In one embodiment, recommended actions 210 describes a specific action (e.g., "Close Tag 9"), which may be further described (automatically in response to a user input) by the corresponding recommendation details 212 (e.g., "Tag 9 controls supplemental heat provided to tank 3"). As a further option, user-specified action 214 receives a user's input different from any of the presented recommended actions 210. The user-specified action 214 may differ from one or more recommended actions 210 in terms of timing (e.g., "silence alarm for 30 minutes") or to initiate another action not provided by the one or more recommended actions 210. In another embodiment, the user-specified action 214 receives a user's input which is associated with the recommended actions 210, for example, the user-specified action 214 may be “please tell me the reason of giving recommendation 1 (210A)”. Following this user-specified action 214, the display 202 may provide reasons of giving recommendation 1 (210A).

The presentation of content on alarm display 202 may utilize various graphical user display (GUI) elements. For example, a portion of alarm display 202 presenting recommended actions 210A-210n may scroll, have pages, etc. Similarly, the corresponding recommended actions 212A-212n may be scroll (such as to the left or right), pop-up, display content in another window, etc. However, presenting the highest priority recommended action (e.g., recommended action 1 (210A) closest to the designated highest priority location 208 is provided to ensure the user can quickly be presented with, and optionally take, the best action to resolve the alarm. The particular location of highest priority location 208 is variously embodied. For example, when presented as text, the location of highest priority location 208 may be determined based on the preferred written language of an operator, such as placing highest priority location 208 in the upper left of a display, window, dialog, etc., when the written language of the operator reads from left to right, then top to bottom. Similarly, highest priority location 208 may be in the upper right of the display, window, dialog, etc., when the preferred written language of the operator reads from right to left, then top to bottom. In another embodiment, alarm display 202 may be overlayed on a graphical representation of industrial site 104 or one or more process components 102. As a result, highest priority location 208 may be a location closest to the image of the particular portion of industrial site 104 or the one or more process components 102 that are associated with the alarm.

Recommended action 1 (210A) may be recommended because performing the associated actions to affect the operational attributes of the industrial process will most quickly resolve the alarm. However, speed may not always be the primary objective to resolve an alarm. In other embodiments, the recommended action 1 (210A) may be selected based on the production of fewer waste projects, lowered risk of escalation of the alarm condition, or resource costs. Similarly, the selection of any subsequent recommended action 2 (210B) through "n" (210n) may be based on speed of resolution and/or waste products, risk of escalation, resource costs, etc.

In another embodiment, when a user selects user-specified action 214, alarm display 202 may provide a selectable listing of process components 102 to receive a specific input to change a process attribute of one or more process components 102. Server 106 then provides signals to the respective process components 102 to implement the user's inputs. In a further embodiment, server 106 may utilize the input as feedback to the decision-making AI process. As a result, any future occurrence of the same or similar alarm will "down weight" the prior recommended actions 210 and "up weight" a recommended action associated with the user's input. In another embodiment, the alarm, state of one or more process components 102, and the user's action selected in user-specified action 214 is provided as an initial or subsequent training to the AI process.

FIG. 3 depicts process 300 in accordance with embodiments of the present disclosure. In one embodiment, process 300 is a computer-implemented method for training a neural network. A neural network, as is known in the art and in one embodiment, self-configures layers of logical nodes having an input and an output. If an output is below a self-determined threshold level, the output is omitted (i.e., the inputs are within the inactive response portion of a scale and provide no output). If the self-determined threshold level is above the threshold, an output is provided (i.e., the inputs are within the active response portion of a scale and provide an output). The particular placement of the active and inactive delineation is provided as a training step or steps. Multiple inputs into a node produce a multi-dimensional plane (e.g., hyperplane) to delineate a combination of inputs that are active or inactive. In another embodiment, process 300 comprises a machine learning module. The machine learning module may use a variety of machine learning algorithms, such as supervised machine learning, unsupervised machine learning, reinforcement machine learning, semi-supervised machine learning, self-supervised machine learning, multi-instance machine learning, inductive machine learning, deductive machine learning, transductive machine learning, and/or the like.

In one embodiment, process 300 begins and, in step 302, a set of past operational attributes of an industrial process are collected. Step 302 may collect the past operational attributes from a database, such as one maintained by data storage 108, and/or other sources. The past operational attributes may comprise values reported by one or more process components 102 observed or reported during a past execution of an industrial process. Next, step 304 applies one or more transformations to each of the past operational attributes, including altering the degree of a first transformation of the one or more transformations, altering the order of the one or more transformations applied to two or more past operational attributes, including a second transformation to an omitted one of the past operational attributes, and omitting at least one transformation of the one or more transformations to an included one of the past operational attributes, to create a modified set of past operational attributes.

Step 306 then creates a first training set comprising the collected set of past operational attributes, the modified set of past operational attributes, and a set of extraneous operational attributes of the industrial process not associated with a prior alarm.

Step 308 trains the neural network in a first stage using the first training set and step 310 then creates a second training set for a second stage of training comprising the first training set and the set of extraneous operational attributes of the industrial process not associated with any prior alarms incorrectly identified as impacting the prior alarm. The neural network is trained in the second stage using the second training set in step 312. The set of extraneous operational attributes may comprise operational attributes that are not associated with the alarm, specifically, the engine determines all operational attributes of the industrial process and identifies the operational attributes that were changed because of the alarm. Then the operational attributes of the industrial process that were changed will be the set of extraneous operational attributes.

Once trained, the neural network may be presented with current operational attributes reported by one or more process components 102 and/or an alarm and return one or more recommended actions, such as recommended actions 210, to resolve the alarm. Additionally or alternatively, the use of a user-specified action 214 (and rejection of the recommended actions 210) may be provided to the neural network to train, retrain, or refine the recommended actions. As a benefit, the neural network may be able to analyze the operational attributes, such as to discover interdependencies between two or more process resources 102 associated with an alarm that were previously unknown. Once known, alarms may be resolved by affecting an operational attribute of at least one of the two or more process resources.

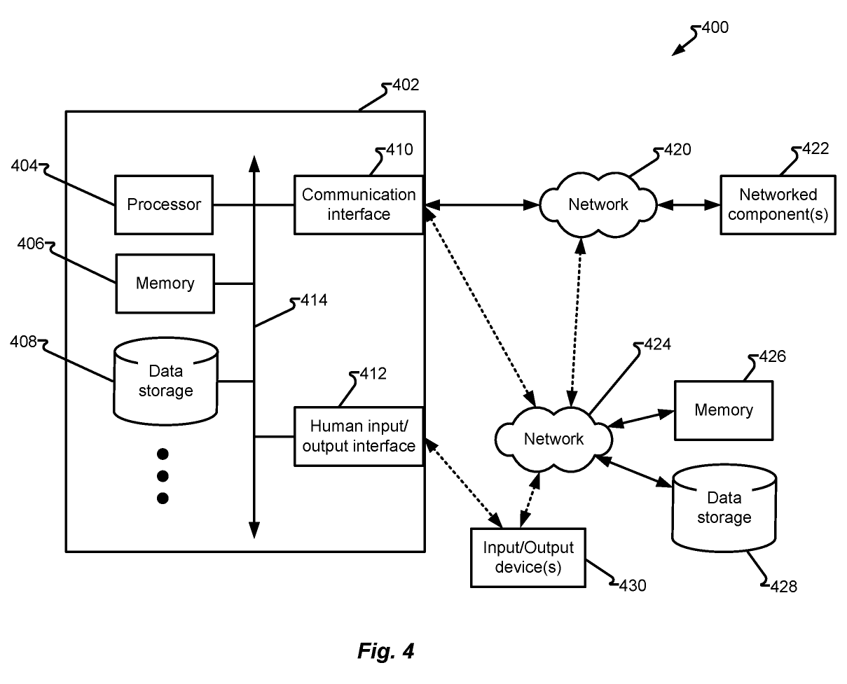

FIG. 4 depicts device 402 in system 400 in accordance with embodiments of the present disclosure. In one embodiment, server 106, computer 110, and/or one or more process components 102 may be embodied, in whole or in part, as device 402 comprising various components and connections to other components and/or systems. The components are variously embodied and may comprise processor 404. The term "processor," as used herein, refers exclusively to electronic hardware components comprising electrical circuitry with connections (e.g., pin-outs) to convey encoded electrical signals to and from the electrical circuitry. Processor 404 may comprise programmable logic functionality, such as determined, at least in part, from accessing machine-readable instructions maintained in a non-transitory data storage, which may be embodied as circuitry, on-chip read-only memory, computer memory 406, data storage 408, etc., that cause the processor 404 to perform the steps of the instructions. Processor 404 may be further embodied as a single electronic microprocessor or multiprocessor device (e.g., multicore) having electrical circuitry therein which may further comprise a control unit(s), input/output unit(s), arithmetic logic unit(s), register(s), primary memory, and/or other components that access information (e.g., data, instructions, etc.), such as received via bus 414, executes instructions, and outputs data, again such as via bus 414. In other embodiments, processor 404 may comprise a shared processing device that may be utilized by other processes and/or process owners, such as in a processing array within a system (e.g., blade, multi-processor board, etc.) or distributed processing system (e.g., "cloud", farm, etc.). It should be appreciated that processor 404 is a non-transitory computing device (e.g., electronic machine comprising circuitry and connections to communicate with other components and devices). Processor 404 may operate a virtual processor, such as to process machine instructions not native to the processor (e.g., translate the VAX operating system and VAX machine instruction code set into Intel® 9xx chipset code to enable VAX-specific applications to execute on a virtual VAX processor). However, as those of ordinary skill understand, such virtual processors are applications executed by hardware, more specifically, the underlying electrical circuitry and other hardware of the processor (e.g., processor 404). Processor 404 may be executed by virtual processors, such as when applications (i.e., Pod) are orchestrated by Kubernetes. Virtual processors enable an application to be presented with what appears to be a static and/or dedicated processor executing the instructions of the application, while underlying non-virtual processor(s) are executing the instructions and may be dynamic and/or split among a number of processors.

In addition to the components of processor 404, device 402 may utilize computer memory 406 and/or data storage 408 for the storage of accessible data, such as instructions, values, etc. Communication interface 410 facilitates communication with components, such as processor 404 via bus 414 with components not accessible via bus 414 and may be embodied as a network interface (e.g., ethernet card, wireless networking components, USB port, etc.). Communication interface 410 may be embodied as a network port, card, cable, or other configured hardware device. Additionally or alternatively, human input/output interface 412 connects to one or more interface components to receive and/or present information (e.g., instructions, data, values, etc.) to and/or from a human and/or electronic device. Examples of input/output devices 430 that may be connected to input/output interface include, but are not limited to, keyboard, mouse, trackball, printers, displays, sensor, switch, relay, speaker, microphone, still and/or video camera, etc. In another embodiment, communication interface 410 may comprise, or be comprised by, human input/output interface 412. Communication interface 410 may be configured to communicate directly with a networked component or configured to utilize one or more networks, such as network 420 and/or network 424.

Network 420 may be a wired network (e.g., Ethernet), wireless (e.g., WiFi, Bluetooth, cellular, etc.) network, or combination thereof and enable device 402 to communicate with networked component(s) 422. In other embodiments, network 420 may be embodied, in whole or in part, as a telephony network (e.g., public switched telephone network (PSTN), private branch exchange (PBX), cellular telephony network, etc.).

Additionally or alternatively, one or more other networks may be utilized. For example, network 424 may represent a second network, which may facilitate communication with components utilized by device 402. For example, network 424 may be an internal network to a business entity or other organization, whereby components are trusted (or at least more so) than networked components 422, which may be connected to network 420 comprising a public network (e.g., Internet) that may not be as trusted.

Components attached to network 424 may include computer memory 426, data storage 428, input/output device(s) 430, and/or other components that may be accessible to processor 404. For example, computer memory 426 and/or data storage 428 may supplement or supplant computer memory 406 and/or data storage 408 entirely or for a particular task or purpose. As another example, computer memory 426 and/or data storage 428 may be an external data repository (e.g., server farm, array, "cloud," etc.) and enable device 402, and/or other devices, to access data thereon. Similarly, input/output device(s) 430 may be accessed by processor 404 via human input/output interface 412 and/or via communication interface 410 either directly, via network 424, via network 420 alone (not shown), or via networks 424 and 420. Each of computer memory 406, data storage 408, computer memory 426, data storage 428 comprise a non-transitory data storage comprising a data storage device.

It should be appreciated that computer readable data may be sent, received, stored, processed, and presented by a variety of components. It should also be appreciated that components illustrated may control other components, whether illustrated herein or otherwise. For example, one input/output device 430 may be a router, a switch, a port, or other communication component such that a particular output of processor 404 enables (or disables) input/output device 430, which may be associated with network 420 and/or network 424, to allow (or disallow) communications between two or more nodes on network 420 and/or network 424. One of ordinary skill in the art will appreciate that other communication equipment may be utilized, in addition or as an alternative, to those described herein without departing from the scope of the embodiments.

In the foregoing description, for the purposes of illustration, methods were described in a particular order. It should be appreciated that in alternate embodiments, the methods may be performed in a different order than that described without departing from the scope of the embodiments. It should also be appreciated that the methods described above may be performed as algorithms executed by hardware components (e.g., circuitry) purpose-built to carry out one or more algorithms or portions thereof described herein. In another embodiment, the hardware component may comprise a general-purpose microprocessor (e.g., CPU, GPU) that is first converted to a special-purpose microprocessor. The special-purpose microprocessor then having had loaded therein encoded signals causing the, now special-purpose, microprocessor to maintain machine-readable instructions to enable the microprocessor to read and execute the machine-readable set of instructions derived from the algorithms and/or other instructions described herein. The machine-readable instructions utilized to execute the algorithm(s), or portions thereof, are not unlimited but utilize a finite set of instructions known to the microprocessor. The machine-readable instructions may be encoded in the microprocessor as signals or values in signal-producing components by, in one or more embodiments, voltages in memory circuits, configuration of switching circuits, and/or by selective use of particular logic gate circuits. Additionally or alternatively, the machine-readable instructions may be accessible to the microprocessor and encoded in a media or device as magnetic fields, voltage values, charge values, reflective/non-reflective portions, and/or physical indicia.

In another embodiment, the microprocessor further comprises one or more of a single microprocessor, a multi-core processor, a plurality of microprocessors, a distributed processing system (e.g., array(s), blade(s), server farm(s), "cloud", multi-purpose processor array(s), cluster(s), etc.) and/or may be co-located with a microprocessor performing other processing operations. Any one or more microprocessors may be integrated into a single processing appliance (e.g., computer, server, blade, etc.) or located entirely, or in part, in a discrete component and connected via a communications link (e.g., bus, network, backplane, etc. or a plurality thereof).

Examples of general-purpose microprocessors may comprise a central processing unit (CPU) with data values encoded in an instruction register (or other circuitry maintaining instructions) or data values comprising memory locations, which in turn comprise values utilized as instructions. The memory locations may further comprise a memory location that is external to the CPU. Such CPU-external components may be embodied as one or more of a field-programmable gate array (FPGA), read-only memory (ROM), programmable read-only memory (PROM), erasable programmable read-only memory (EPROM), random access memory (RAM), bus-accessible storage, network-accessible storage, etc.

These machine-executable instructions may be stored on one or more machine-readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

In another embodiment, a microprocessor may be a system or collection of processing hardware components, such as a microprocessor on a client device and a microprocessor on a server, a collection of devices with their respective microprocessor, or a shared or remote processing service (e.g., "cloud" based microprocessor). A system of microprocessors may comprise task-specific allocation of processing tasks and/or shared or distributed processing tasks. In yet another embodiment, a microprocessor may execute software to provide the services to emulate a different microprocessor or microprocessors. As a result, a first microprocessor, comprised of a first set of hardware components, may virtually provide the services of a second microprocessor whereby the hardware associated with the first microprocessor may operate using an instruction set associated with the second microprocessor.

While machine-executable instructions may be stored and executed locally to a particular machine (e.g., personal computer, mobile computing device, laptop, etc.), it should be appreciated that the storage of data and/or instructions and/or the execution of at least a portion of the instructions may be provided via connectivity to a remote data storage and/or processing device or collection of devices, commonly known as "the cloud," but may include a public, private, dedicated, shared and/or other service bureau, computing service, and/or "server farm."

Examples of the microprocessors as described herein may include, but are not limited to, at least one of Qualcomm® Snapdragon® 800 and 801, Qualcomm® Snapdragon® 610 and 615 with 4G LTE Integration and 64-bit computing, Apple® A7 microprocessor with 64-bit architecture, Apple® M7 motion comicroprocessors, Samsung® Exynos® series, the Intel® Core™ family of microprocessors, the Intel® Xeon® family of microprocessors, the Intel® Atom™ family of microprocessors, the Intel Itanium® family of microprocessors, Intel® Core® i5-4670K and i7-4770K 22nm Haswell, Intel® Core® i5-3570K 22nm Ivy Bridge, the AMD® FX™ family of microprocessors, AMD® FX-4300, FX-6300, and FX-8350 32nm Vishera, AMD® Kaveri microprocessors, Texas Instruments® Jacinto C6000™ automotive infotainment microprocessors, Texas Instruments® OMAP™ automotive-grade mobile microprocessors, ARM® Cortex™-M microprocessors, ARM® Cortex-A and ARM926EJ-S™ microprocessors, other industry-equivalent microprocessors, and may perform computational functions using any known or future-developed standard, instruction set, libraries, and/or architecture.

Any of the steps, functions, and operations discussed herein can be performed continuously and automatically.

The exemplary systems and methods of this invention have been described in relation to communications systems and components and methods for monitoring, enhancing, and embellishing communications and messages. However, to avoid unnecessarily obscuring the present invention, the preceding description omits a number of known structures and devices. This omission is not to be construed as a limitation of the scope of the claimed invention. Specific details are set forth to provide an understanding of the present invention. It should, however, be appreciated that the present invention may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components or portions thereof (e.g., microprocessors, memory/storage, interfaces, etc.) of the system can be combined into one or more devices, such as a server, servers, computer, computing device, terminal, "cloud" or other distributed processing, or collocated on a particular node of a distributed network, such as an analog and/or digital telecommunications network, a packet-switched network, or a circuit-switched network. In another embodiment, the components may be physical or logically distributed across a plurality of components (e.g., a microprocessor may comprise a first microprocessor on one component and a second microprocessor on another component, each performing a portion of a shared task and/or an allocated task). It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users’ premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the invention.

A number of variations and modifications of the invention can be used. It would be possible to provide for some features of the invention without providing others.

In yet another embodiment, the systems and methods of this invention can be implemented in conjunction with a special purpose computer, a programmed microprocessor or microcontroller and peripheral integrated circuit element(s), an ASIC or other integrated circuit, a digital signal microprocessor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this invention. Exemplary hardware that can be used for the present invention includes computers, handheld devices, telephones (e.g., cellular, Internet enabled, digital, analog, hybrids, and others), and other hardware known in the art. Some of these devices include microprocessors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein as provided by one or more processing components.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this invention can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Embodiments herein comprising software are executed, or stored for subsequent execution, by one or more microprocessors and are executed as executable code. The executable code being selected to execute instructions that comprise the particular embodiment. The instructions executed being a constrained set of instructions selected from the discrete set of native instructions understood by the microprocessor and, prior to execution, committed to microprocessor-accessible memory. In another embodiment, human-readable "source code" software, prior to execution by the one or more microprocessors, is first converted to system software to comprise a platform (e.g., computer, microprocessor, database, etc.) specific set of instructions selected from the platform's native instruction set.

Although the present invention describes components and functions implemented in the embodiments with reference to particular standards and protocols, the invention is not limited to such standards and protocols. Other similar standards and protocols not mentioned herein are in existence and are considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

What is claimed is:

1. A computer-implemented method of training a neural network for alarm resolution actions, comprising:
collecting a set of past operational attributes of an industrial process;
applying one or more transformations to each of the past operational attributes of the set of past operational attributes of the industrial process including altering the degree of a first transformation of the one or more transformations, altering the order of the one or more transformations applied to two or more past operational attributes, including a second transformation to an omitted one of the past operational attributes of the set of past operational attributes, and omitting at least one transformation of the one or more transformations to an included one of the past operational attributes to create a modified set of past operational attributes;
creating a first training set comprising the collected set of past operational attributes, the modified set of past operational attributes, and a set of extraneous operational attributes of the industrial process not associated with a prior alarm;
training the neural network in a first stage using the first training set;
creating a second training set for a second stage of training comprising the first training set and the set of extraneous operational attributes of the industrial process not associated with any prior alarms incorrectly identified as impacting the prior alarm; and
training the neural network in the second stage using the second training set.

2. The computer-implemented method of claim 1, further comprising:
receiving an alarm associated with the industrial process reporting an alarm state of at least one operational attribute of the industrial process; and
in response to the alarm:
providing a set of operational attributes of the industrial process and the alarm to the neural network to receive a recommended resolution action from the neural network;
presenting, on a graphical user interface (GUI), an indicium of the recommended resolution action and at least one action different from the recommended resolution action;
receiving a selected action identifying one of the recommended resolution action and the at least one action different from the recommended resolution action; and
modifying at least one process component of the industrial process in accordance with the selected action.

3. The computer-implemented method of claim 2, wherein:
the recommended resolution action is a plurality of prioritized recommended resolution actions;
presenting a recommendation on the GUI comprises presenting, in priority order, the plurality of prioritized recommended resolution actions;
receiving the selected action identifying one of the plurality of prioritized recommended resolution actions and the at least one action different from the plurality of prioritized recommended resolution actions; and
modifying at least one process component of the industrial process in accordance with the selected action.

4. The computer-implemented method of claim 3, wherein the priority order is one or more of a faster resolution of the alarm, fewer waste products generated by the industrial process, less risk of an escalation alarm, and lower resource requirements.

5. The computer-implemented method of claim 3, further comprising:
monitoring the impact of the selected action on the set of operational attributes; and
providing feedback to the neural network comprising the selected action and the impact.

6. The method of claim 1, wherein the set of operational attributes comprise a set of one or more of a reading from a sensor, a parameter of a process component utilized by the industrial process, and a parameter of an algorithm utilized to operate one or more process components utilized by the industrial process.

7. A computer-implemented method, comprising:
collecting a set of operational attributes of an industrial process;
analyzing the set of operational attributes to identify subsets of operational attributes being interdependent;
receiving an alarm for the industrial process; and
in response to the alarm:
identifying a subset of operational attributes associated with the alarm;
identifying a first operational attribute, of the subset of operational attributes associated with the alarm, triggering the alarm;
identifying a second operational attribute interdependent on the first operational attribute;
presenting indicium of the second operational attribute on a graphical user interface (GUI) and receiving a modification input therefrom; and
modifying the second operational attribute in accordance with the modification input.

8. The computer-implemented method of claim 7, wherein:
identifying the subset of operational attributes associated with the alarm comprises identifying a plurality of subsets of operational attributes associated with the alarm;
identifying the first operational attribute, of the subset of operational attributes associated with the alarm, triggering the alarm, comprises identifying a set of first operational attributes, of each of the plurality of subsets of operational attributes associated with the alarm, triggering the alarm;
identifying the second operational attribute interdependent on the first operational attribute comprises identifying the second operational attributes interdependent on the set of first operational attributes; and
presenting indicium of the second operational attribute on the GUI and receiving the modification input therefrom comprises presenting a set of indicia of the second operational attribute on the GUI and receiving the modification input therefrom.

9. The computer-implemented method of claim 8, further comprising:
prioritizing the set of second operational attributes to form a prioritized list of second operational attributes; and
moving indicium of the highest priority of the prioritized list of second operational attributes closest to a highest priority location of the GUI.

10. The computer-implemented method of claim 8, further comprising:
moving indicia of the highest priority operational attributes of the set of second operational attributes closest to a highest priority location of the GUI based on priority.

11. The computer-implemented method of claim 10, wherein the priority of the highest priority operational attributes is one or more of a faster resolution of the alarm, fewer waste products generated by the industrial process, less risk of an escalation alarm, and lower resource requirements.

12. The computer-implemented method of claim 7, wherein analyzing the set of operational attributes to identify subsets of operational attributes being interdependent, comprises:
collecting a set of past operational attributes of an industrial process;
applying one or more transformations to each of the past operational attributes of the set of past operational attributes including altering the degree of a first transformation of the one or more transformations, altering the order of the one or more transformations applied to two or more past operational attributes, including a second transformation to an omitted one of the set of past operational attributes, and omitting at least one transformation of the one or more transformations to an included one of the set of past operational attributes to create a modified set of past operational attributes;
creating a first training set comprising the collected set of past operational attributes, the modified set of past operational attributes, and a set of extraneous operational attributes of the industrial process not associated with a prior alarm;
training a neural network in a first stage using the first training set;
creating a second training set for a second stage of training comprising the first training set and the set of extraneous operational attributes of the industrial process not associated with any prior alarms incorrectly identified as impacting the prior alarm; and
training the neural network in the second stage using the second training set.

13. The computer-implemented method of claim 7, wherein the set of operational attributes comprise a set of one or more of: a reading from a sensor, a parameter of a process component utilized by the industrial process, and a parameter of an algorithm utilized to operate one or more process components utilized by the industrial process.

14. A system, comprising:
a database; and
a processor, coupled to a computer memory maintaining thereon instructions to cause the processor to execute the instructions; and
wherein the instructions cause the processor to perform:
collecting a set of past operational attributes of an industrial process from the database;
applying one or more transformations to each of the past operational attributes of the set of past operational attributes including altering the degree of a first transformation of the one or more transformations, altering the order of the one or more transformations applied to two or more past operational attributes, including a second transformation to an omitted one of the past operational attributes of set of past operational attributes, and omitting at least one transformation of the one or more transformations to an included one of the past operational attributes of the set of past operational attributes to create a modified set of past operational attributes;
creating a first training set comprising the collected set of past operational attributes, the modified set of past operational attributes, and a set of extraneous operational attributes of the industrial process not associated with a prior alarm;
training a neural network in a first stage using the first training set;
creating a second training set for a second stage of training comprising the first training set and the set of extraneous operational attributes of the industrial process not associated with any prior alarms incorrectly identified as impacting the prior alarm; and
training the neural network in the second stage using the second training set.

15. The system of claim 14, further comprising:
a network interface to a network; and
a user device comprising the processor and a graphical user interface (GUI); and
wherein the instructions further cause the processor to perform:
receiving, via the network, an alarm associated with the industrial process reporting an alarm state of at least one operational attribute of the industrial process;
in response to the alarm:
providing a set of operational attributes of the industrial process and the alarm to the neural network to receive a recommended resolution action from the neural network;
presenting, on the GUI, indicium of the recommended resolution action and at least one action different from the recommended resolution action;
receiving a selected action identifying the recommended resolution action and the at least one action different from the recommended resolution action; and
modifying at least one process component of the industrial process in accordance with the selected action.

16. The system of claim 15, wherein:
the recommended resolution action is a plurality of prioritized recommended resolution actions;
presenting the recommended resolution action on the GUI comprises presenting, in priority order, the plurality of prioritized recommended resolution actions;
receiving the selected action identifying the recommended resolution action and the at least one action different from the recommended resolution action comprises receiving the selected action identifying one of the plurality of prioritized recommended resolution actions and the at least one action different from the plurality of prioritized recommended resolution actions; and
modifying at least one process component of the industrial process in accordance with the selected action comprises modifying at least one process component of the industrial process in accordance with the selected action.

17. The system of claim 16, wherein presenting the recommended resolution action on the GUI comprises presenting, in the priority order, the plurality of prioritized recommended resolution actions and further comprises moving indicium of the highest priority of the plurality of prioritized recommended resolution actions closest to a highest priority location of the GUI.

18. The system of claim 16, wherein the priority order is one or more of a faster resolution of the alarm, fewer waste products generated by the industrial process, less risk of an escalation alarm, and lower resource requirements.

19. The system of claim 16, wherein the instructions further cause the processor to perform:
monitoring the impact of the selected action on the set of operational attributes; and
providing feedback to the neural network comprising the selected action and the impact.

20. The system of claim 15, wherein the set of operational attributes comprise a set of one or more of a reading from a sensor, a parameter of a process component utilized by the industrial process, and a parameter of an algorithm utilized to operate one or more process components utilized by the industrial process.
